(19) United States
(12) Patent Application Publication
(10) Pub. No.: US 2010/0150323 A1
(43) Pub. Date: Jun. 17, 2010

(54) Method of Addressing Time Wastage During Telephone Call Holds

(75) Inventors: Alan W. Grattan, Santa Cruz, CA (US); Beatrice L. Casanova, San Jose, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/336,464

(22) Filed: Dec. 16, 2008

(51) Int. Cl. H04M 11/00; H04M 3/42

(52) U.S. Cl. 379/88.18; 379/215.01

(57) ABSTRACT

In a telephone communication system, a caller is provided with the facility for leaving a message with the called party or a central office or other network storage location if placed on hold to allow the caller to be notified once he or she is taken off hold.

### FIELD OF THE INVENTION

The present invention relates to telephone communication systems. In particular it deals with telephone systems having a call on hold feature.

### BACKGROUND OF THE INVENTION

In an age where meetings and other arrangements are often made by telephone it is not uncommon to waste large amounts of time waiting on hold while other callers are being handled. The caller is essentially captive to the phone while waiting in a queue for an indeterminate length of time. This results in loss of productivity while waiting for the called party to be ready to receive the call.

Often the caller is subjected to sales promotions or on-hold music during this period, without much choice but to sit and wait. If the caller decides to end the call and place a new call he is once again placed at the end of the queue.

Thus any other incoming calls, or events that may require the caller to step away from the phone such as a bathroom stop, the need to answer the door or to get something from the refrigerator becomes a choice between hanging up the call and starting again or risking not being available when the called party is ready to respond.

One solution to help reduce the tension and frustration caused by long queues, has been to provide a predicted time or queue length as part of an on-hold message e.g. “You are next” or “Your call will be answered in approximately 10 minutes. Please continue to hold.” However, this solution, while possibly reducing stress by providing the caller with some information, fails to address the underlying issue of time wastage.

### SUMMARY OF THE INVENTION

According to the invention, there is provided a method of addressing telephone call holds, comprising providing a user interface for the caller making a call to record a message or select a pre-recorded or pre-defined message for the called party while the call is still connected to the called party. The pre-recorded or pre-defined message may be a user-intelligible message or a message operable to cause the called party's phone to generate a signaling message once the caller is taken off hold. The message to the called party's phone once the called party takes the caller off hold may be generated from the caller's phone or from a central office or parallel processor or other network handling facility.

Thus the method may include the caller selecting or recording a message while on-hold. For purposes of this application the term “on-hold” will be used to refer to situations where a call-on-hold feature is activated by the called party or where the called or receiving party simply steps away from the phone or mutes the phone. The method further includes means for identifying when the call is no longer on hold. The receiving or called party may for instance de-activate the call-on-hold button, take the phone off mute, or provide an audible response such as talk into the phone. In accordance with one embodiment of the invention the message for the called party may instruct the called party to press a button or sequence of buttons to notify the caller that the call is no longer on hold. The means for notifying the caller may include signaling, e.g., a (dual tone multiple frequency) DTMF signal generated from the called or receiving party's phone directly or through a central office. The signaling may be achieved through in-band or out-of-band signaling. In one embodiment, the de-activation of the call-on-hold button or taking the phone off mute may be operable to generate a supervisory signal, which may be used by a central office or a parallel processor or other network handling facility to generate an alerting signal to alert the calling party or caller that the call is no longer on hold. In another embodiment the de-activation of the call-on-hold button or taking the phone off mute may be operable to generate an alerting signal directly to the caller's phone.

The alerting signal, e.g., DTMF message may be operable to ring the caller's (also referred to herein as the calling party's) phone. The alerting signal may cause the caller's phone to ring according to a pre-defined ring pattern or pre-defined or pre-selected tune or other audible signal.

The means for identifying when a call is no longer on hold may include means for identifying an audible response. The means for identifying an audible response may include at least one of voice recognition software, and a comparator for comparing a incoming verbal response to a set of predefined verbal responses.

The user interface for the caller's phone may include a recording medium for recording a message and may include one or more buttons that are predefined to allow the caller to record a message on the recording medium. The user interface may instead or, in addition include one or more buttons that are predefined to select one or more predefined messages. The message may include a call-back number, which may be the user's number, the number of a central office or another number. The user interface may further include a screen to view one or more predefined messages. In the case of the caller's phone being a cell phone, personal organizer or other hand-held device that has the capability to download ring-tones or tunes, the caller's phone may be adapted to provide a distinguishing ring-tone or tune to notify the caller that a previously called party has taken the caller off hold. The user interface screen may also be adapted to identify an incoming call by number or party's name.

### BRIEF DESCRIPTION OF THE DRAWINGS

FIG. 1 is a schematic representation of a prior art telephone network making use of signaling information to control telephone calls, and

FIG. 2 is a schematic representation of one embodiment of a telephone arrangement of the invention.

### DETAILED DESCRIPTION OF THE INVENTION

The present invention provides a system and means for avoiding the frustration and time wastage caused by being placed on hold during a telephone call. In accordance with the invention, the caller who is placed on hold is given the facility to leave a message for the called party while being on hold, thereby freeing him or her up to do other things or receive or place new telephone calls. As will become clearer from the description below, the message may be verbal and addressed to the called party or may be a signal or message to the called party's telephone (e.g., a DTMF message to the calling party's phone to cause the caller's phone to ring when the called party takes the caller off hold), and may be generated by the caller or by a central office in response to the caller generating a message or selecting a predefined message.

Thus the present invention also envisages simply submitting an initial signaling message (e.g., a dual tone multiple frequency (DTMF) message) to the called party's phone, e.g., by pressing a defined button or sequence of buttons on the caller side that will cause the called telephone, in turn, to generate a responding signaling message once the called party takes the caller off hold, resulting in the caller's phone receiving a “ring” instruction. Also, in one embodiment, instead of the caller recording a message for the called party or selecting a message from a pre-defined set of messages that is sent directly to the called party's phone, the initial signaling message sent from the caller's phone is received by a central office and causes a previously generated message to be sent from the central office to the called party when the called party takes the caller off hold. The message may for instance specify that certain action is required of the called party.

As indicated above, the instructions to and from the called party are typically implemented by making use of signaling (either in-channel or out-of-band), which is best understood by considering a common telephone network arrangement.

When a telephone call is placed by a caller to a called party, one or more networks are typically involved. In order to control, route and maintain a telephone call, signaling is used, which involves sending information between two parts of a network. For instance, when the caller lifts the handset of a telephone, this sends a message to a central office that the caller wishes to make a call. In response, the central office sends back a signal to the caller in the form of a dial tone indicating that the network is ready to carry the call. Three types of signaling may be identified: (a) Supervisory signals, which monitor the busy or idle condition of a telephone, request service, and advise the central office when a phone is taken off the hook; (b) Alerting signals which alert the called party that a call has arrived, e.g. by activating a tone, bell or strobe light; (c) Addressing signals, which take the form of data pulses or touch tones that tell the network where to send the call.

These signals may be sent over the same channel as the voice or data (in-channel signaling) or over a separate channel (out-of-band or common channel), the latter providing for intelligent routing and access to applications in public switched telephone networks (PSTNs) and applications in Internet Protocol (IP) networks.

In the Signaling System 7 (SS7) protocol, the routing intelligence is located in lower cost computer based peripherals rather than in central office switches. Parallel processing computers control databases with information such as routing instructions for toll-free and 900 calls. This frees up the central office switch, which no longer has to maintain routing information.

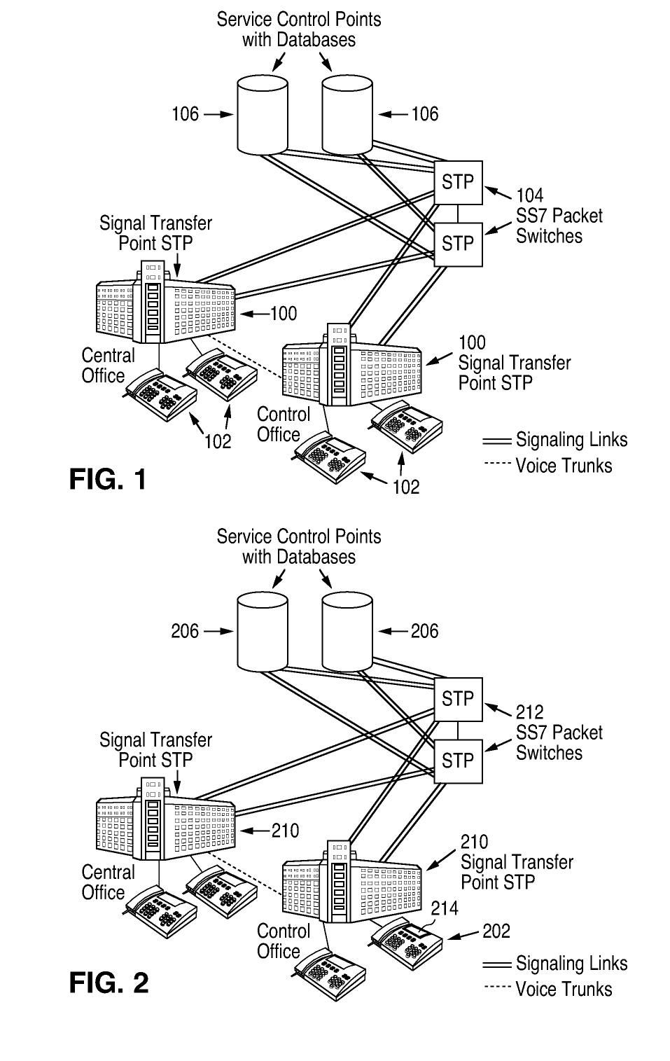

A typical telephone network arrangement with two central offices 100, connected to end users 102 is shown in FIG. 1, connected through SS7 Packet switches 104 to service control points with databases 106.

In one embodiment of the invention, shown in FIG. 2, an arrangement similar to that of FIG. 1 is provided, but the databases 206 in this embodiment include multiple pre-generated messages. The databases 206 at the service control points are connected to the central offices 210 through packet switches 212. The caller's telephone 202, in turn is provided with a display screen 214 that allows the caller to view the pre-generated messages in response to pressing a pre-defined key or set of keys. Scrolling through and selecting of a message can be achieved through the use of dedicated scroll-bar controllers or keys or through number selection using the phone's key pad. In one embodiment for use in standard public switched telephone networks (PSTNs), it is proposed to adapt certain number keys to perform specific functions, such as entering recording mode for recording on a local recording device or on a storage medium at the central office 210, or for requesting a message selection menu to be displayed on a display screen on the caller's phone. In an even simpler embodiment, instead of providing the phone with a display screen, the menu options may simply be played to the caller for selection by choosing the appropriate number corresponding to the selected message.

In the case of a multimedia device such as a Palm Pilot or other PDA the existing touch-sensitive screens, scroll-wheels or pads, scribes, and buttons can be defined to perform menu selection functions.

As indicated above, in one embodiment, the caller's phone may be provided with a recording device with a recording medium and control buttons for recording message at the time that the caller wishes to leave a message for the called party, while in another embodiment, the message is still created by the user, but instead of providing for a recording device on the caller's phone, the central office 210 or a parallel processing computer may include a recording device that the caller can leave a message on for subsequent playing to the called party once the called party takes the caller off hold. It will therefore be appreciated that for purposes of this invention, the existence of a recording facility to leave a message for a called party while the calling party is kept on hold, is indicative of only one embodiment, provided the caller can subsequently be accessed by the called party when the called party takes the calling party off hold, without requiring the called party to manually dial the number of the calling party.

As discussed above, in a preferred embodiment this is achieved through the use of messaging to the called party's phone and then back to the caller once the caller is taken off hold. The messaging may be a message that is intelligible to a user (in this case the called party) or may simply be a signaling message to the called party's phone to cause it to establish contact automatically with the caller's phone once the called party takes the caller off hold.

While the signaling message may be sent directly from the caller to the called party's phone, in one embodiment the signaling message is sent to a central office or to a parallel processor or other network handling facility and the caller is notified from a central office or a parallel processor or other network handling facility (e.g., by DTMF signal) when the caller is no longer on hold. In this latter embodiment, the called party's phone generates a signaling message to a central office or a parallel processor or other network handling facility when the caller is taken off hold. The central office then notifies the calling party's phone by generating an alerting signal that causes the caller's phone to ring or provide a visual response.

In one embodiment, the alerting signal instructs the caller's phone to ring according to a pre-define ring pattern or pre-defined or pre-selected tune or other audible signal. For instance in the case of cell-phones or PDAs, ring tones or tunes may be downloaded and the device, which in this case defines the caller's phone, may be programmed to distinguish new incoming calls from notifications sent by previously called parties that the called party has taken the caller off hold. In one embodiment the screen on the caller's phone may be used to identify the name or number of the incoming call and may also visually identify the incoming call as a notification of a previously called party having taken the caller off hold.

In an embodiment in which a user-intelligible message is sent to the called party, it is either generated at the time, while the caller is on hold, or is selected from a pre-defined set of messages to allow the called party to be addressed or given instructions once he or she takes the caller off hold. For instance, the called party may be given a message to hit one or more keys to indicate to the caller that he or she is no longer on hold. Also, it will be appreciated that the specific location of the recording device or medium is not important and can be implemented at the caller's phone or a central location or at any existing or separately implemented parallel processing computer or other processing device in a telephone network.

Also, while the above embodiments dealt largely with land lines, the invention is not so limited but includes IP (Internet Protocol) networks.

What is claimed is:

1. A method of addressing telephone call holds, comprising:
providing a user interface for the caller making a call to record a message or select a pre-recorded or pre-defined message for the called party while the call is on hold.

2. The method of claim 1, wherein the pre-recorded or pre-defined message includes a user-intelligible message or a message operable to cause the called party's phone to generate a signaling message once the caller is taken off hold.

3. The method of claim 1, wherein the message to the called party's phone is sent from the caller's phone or from a central office or parallel processor or other network handling facility.

4. The method of claim 1, wherein the caller is kept on hold by a call-on-hold feature activated by the called party or by the called party stepping away from the phone or muting the phone.

5. The method of claim 4, further including identifying when the call is no longer on-hold.

6. The method of claim 5, wherein the identifying when the call is no longer on-hold includes identifying the called party de-activating the call-on-hold feature, taking the phone off mute, or providing an audible response such as talking into the phone.

7. The method of claim 1, wherein the message for the called party instructs the called party to press a button or sequence of buttons to notify the caller that the call is no longer on hold.

8. The method of claim 6, wherein the message for the called party instructs the called party to press a button or sequence of buttons to notify the caller that the call is no longer on hold.

9. The method of claim 6, wherein, the de-activation of the call-on-hold feature or taking the phone off mute is operable to generate a supervisory signal.

10. The method of claim 9, wherein the supervisory signal is used by a central office or a parallel processor or other network handling facility to generate an alerting signal to alert the calling party that the call is no longer on hold.

11. The method of claim 10, wherein the de-activation of the call-on-hold feature or taking the phone off mute is operable to generate an alerting signal directly to the caller's phone.

12. The method of claim 11, wherein the alerting signal causes the caller's phone to ring according to a unique audible signal.

13. The method of claim 12, wherein the alerting signal causes the caller's phone to ring according to a unique audible signal.

14. The method of claim 6, wherein the identifying when a call is no longer on hold includes identifying an audible response.

15. The method of claim 14, wherein the identifying of an audible response includes invoking at least one of voice recognition software, and a comparator for comparing a incoming verbal response to a set of predefined verbal responses.

16. The method of claim 1, wherein the user interface includes one or more buttons that are predefined to activate a recorder to allow the caller to record a message.

17. The method of claim 1, wherein the user interface includes one or more buttons that are predefined to select one or more predefined messages.

18. The method of claim 17, wherein at least one of the messages includes a call-back number.

19. The method of claim 18, wherein the call-back number comprises the user's number, the number of a central office or another number.

20. The method of claim 1, wherein the user interface includes a screen to view one or more predefined messages.
